(19) United States
(12) Patent Application Publication
(10) Pub. No.: US 2010/0123800 A1
(43) Pub. Date: May 20, 2010

(54) DIGITAL PHOTOGRAPHING APPARATUS, METHOD OF CONTROLLING THE SAME, AND RECORDING MEDIUM HAVING STORED THEREON COMPUTER PROGRAM FOR IMPLEMENTING THE METHOD

(75) Inventors: Young-geol Kim, Suwon-si (KR); Won-kyu Jang, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/582,842

(22) Filed: Oct. 21, 2009

(30) Foreign Application Priority Data
Nov. 18, 2008 (KR) 10-2008-0114859

(51) Int. Cl. H04N 5/76

(52) U.S. Cl. 348/231.99; 348/E05.031

(57) ABSTRACT

Provided are a digital photographing apparatus enabling easily selection of a degree of exposure when viewing a display, a method of controlling the same, and a computer readable recording medium comprising a computer program for executing the method. The apparatus includes an imaging device for generating data from incident light, a memory for storing data generated by the imaging device, a display for displaying an image corresponding to data generated by the imaging device or an image corresponding to data stored in the memory, and a storage medium for storing an image file corresponding to data generated by the imaging device or an image file corresponding to data stored in the memory, wherein data generated by the imaging device during a preset time interval is accumulatively stored in the memory while the imaging device is exposed, and the display displays a corresponding image while the imaging device is exposed.

### CROSS-REFERENCE TO RELATED PATENT APPLICATION

This application claims the benefit of Korean Patent Application No. 10-2008-0114859, filed on Nov. 18, 2008, in the Korean Intellectual Property Office, the disclosure of which is incorporated herein in its entirety by reference.

### BACKGROUND

The present invention relates to a digital photographing apparatus, a method of controlling the same, and a recording medium having recorded thereon a computer program comprising instructions to be executed on a processor to implement the method, and more particularly, to a digital photographing apparatus which enables a user to easily select exposure when viewing a display unit, a method of controlling the same.

Generally, a digital photographing apparatus generates data from light incident to an imaging device and stores image files in a storage medium by using the generated data. During the process, a digital photographing apparatus allows light to be incident to an imaging device, that is, allows the imaging device to be exposed to light for a time interval either automatically calculated or preset by a user.

When photographing night scenes by using such a conventional digital photographing apparatus, the digital photographing apparatus captures images within a time interval during which an imaging device is exposed, where the time interval is either automatically calculated or preset by a user. However, when a digital photographing apparatus captures night scene images within an automatically calculated time interval during which an imaging device is exposed, since a digital photographing apparatus cannot distinguish between night and day, a digital photographing apparatus captures nighttime images by using the same settings as those used for capturing daytime images. Thus, night scene images obtained by a digital photographing apparatus are too bright. Furthermore, when a digital photographing apparatus captures night scene images within a preset time interval during which an imaging device is exposed, it is necessary for a user to know an appropriate time interval for an imaging device to be exposed prior to performing an image capturing operation. Thus, if required, it is necessary for a user to repeatedly perform the image capturing operation a plurality of times for each different time interval during which an imaging device is exposed to obtain night scene images which satisfy the user.

### SUMMARY

The present invention provides a digital photographing apparatus which enables a user to easily select a degree of exposure when viewing a display unit, a method of controlling the same, and a computer readable recording medium having recorded thereon a computer program for executing the method.

According to an aspect of the present invention, there is provided a digital photographing apparatus including an imaging device for generating data from light incident thereto, a memory for storing data generated by the imaging device, a display unit for displaying an image corresponding to data generated by the imaging device or an image corresponding to data stored in the memory, and a storage medium for storing an image file corresponding to data generated by the imaging device or an image file corresponding to data stored in the memory, wherein data generated by the imaging device during a preset time interval is accumulatively stored in the memory while the imaging device is exposed, and the display unit displays an image corresponding to accumulated data stored in the memory while the imaging device is exposed.

When data generated by the imaging device during the preset time interval is accumulatively stored in the memory while the imaging device is exposed, the imaging device is reset at every preset time interval.

When an image corresponding to accumulated data stored in the memory is displayed while the imaging device is exposed, an image displayed on the display unit is updated at every preset time interval to a next image corresponding to accumulated data stored in the memory.

When a signal is applied by a user while the imaging device is exposed, an image file corresponding to accumulated data stored in the memory is stored in the storage medium.

An image file corresponding to accumulated data stored in the memory is stored in the storage medium at every time interval.

When an image corresponding to accumulated data stored in the memory is displayed while the imaging device is exposed, the image corresponding to the accumulated data stored in the memory is displayed after being resized.

According to another aspect of the present invention, there is provided a method of controlling a digital photographing apparatus, which includes an imaging device for generating data from light incident thereto, a memory for storing data generated by the imaging device, a display unit for displaying an image corresponding to data generated by the imaging device or an image corresponding to data stored in the memory, and a storage medium for storing an image file corresponding to data generated by the imaging device or an image file corresponding to data stored in the memory, the method including accumulatively storing data generated by the imaging device in the memory at every preset time interval while the imaging device is exposed, and includes displaying an image corresponding to accumulated data stored in the memory on the display unit while the imaging device is exposed.

When data generated by the imaging device during the preset time interval is accumulatively stored in the memory while the imaging device is exposed, the imaging device is reset at every preset time interval.

When an image corresponding to accumulated data stored in the memory is displayed while the imaging device is exposed, an image displayed on the display unit is updated at every preset time interval to a next image corresponding to accumulated data stored in the memory.

When a signal is applied by a user while the imaging device is exposed, an image file corresponding to accumulated data stored in the memory is stored in the storage medium.

An image file corresponding to accumulated data stored in the memory is stored in the storage medium at every time interval.

When an image corresponding to accumulated data stored in the memory is displayed while the imaging device is exposed, the image corresponding to the accumulated data stored in the memory is displayed after being resized.

According to another aspect of the present invention, there is provided computer program product, comprising a computer usable medium having a computer readable program code embodied therein, said computer readable program code adapted to be executed to implement the method.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a digital photographing apparatus according to an embodiment of the present invention;

FIG. 2A is a timing diagram illustrating an example of processes performed during an image capturing operation of the digital photographing apparatus of FIG. 1;

FIG. 2B is a timing diagram illustrating another example of processes performed during an image capturing operation of the digital photographing apparatus of FIG. 1

FIG. 3 is a pictorial diagram showing images displayed on a display unit when images are captured by using the digital photographing apparatus of FIG. 1; and

FIG. 4 is a flowchart of a method of controlling a digital photographing apparatus, according to an embodiment of the present invention.

### DETAILED DESCRIPTION OF THE EMBODIMENTS

Hereinafter, the present invention will be described in detail by explaining preferred embodiments of the invention with reference to the attached drawings. Like reference numerals in the drawings denote like elements.

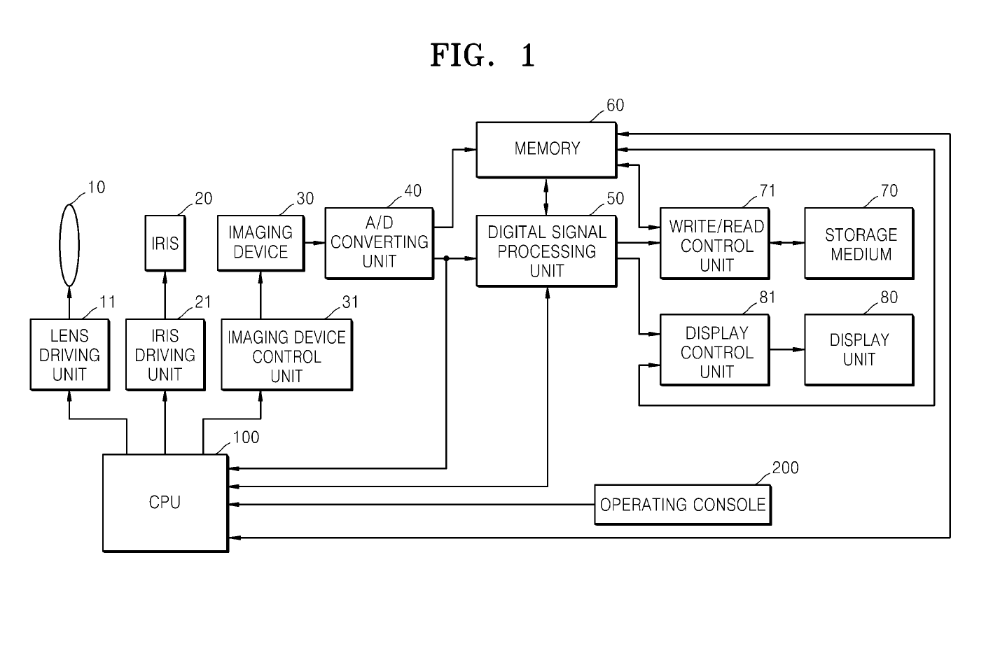

FIG. 1 is a block diagram illustrating a digital photographing apparatus according to an embodiment of the present invention.

Operations of the digital photographing apparatus are controlled by a CPU 100. Furthermore, the digital photographing apparatus includes an operating console 200 including keys for generating electric signals in response to user operation. Electric signals from the operating console 200 are transmitted to the CPU 100, so that the CPU 100 can control the digital photographing apparatus according to the electric signals.

In the case of an image capturing mode, as electric signals from a user are transmitted to the CPU 100, the CPU 100 recognizes the signals and controls a lens driving unit 11, an iris driving unit 21, and an imaging device control unit 31. As a result, a position of a lens 10, an opening of an iris 20, and the sensitivity of an imaging device 30 are controlled. The imaging device 30 generates data from light incident thereto, and an analog/digital converting unit 40 converts analog data output by the imaging device 30 to digital data. However, the analog/digital converting unit 40 may not be necessary according to characteristics of the imaging device 30.

Data output by the imaging device 30 may be input to a digital signal processing unit 50 via a memory 60, may be directly input to the digital signal processing unit 50, and, if required, may be input to the CPU 100. Here, the memory 60 may refer to read-only memory (ROM), random-access memory (RAM), etc. The digital signal processing unit 50 may perform digital signal processing, such as gamma correction, white balance adjustment, etc., if required.

Digital data output by the digital signal processing unit 50 is transmitted to a display control unit 81 either directly or via the memory 60. The display control unit 81 controls a display unit 80 to display the digital data. Furthermore, digital data output by the digital signal processing unit 50 is input to a write/read control unit 71 either directly or via the memory 60. The write/read control unit 71 stores the digital data either according to a signal from a user or automatically. The write/read control unit 71 may also read digital data from digital files stored in a storage medium 70 and input the digital data to the display control unit 81 either via the memory 60 or elsewhere such that the digital data is displayed on the display unit 80. The storage medium 70 may be either removable from or permanently installed in a digital photographing apparatus.

A digital photographing apparatus according to the current embodiment accumulatively stores data generated by the imaging device 30 at every preset time interval while the imaging device 30 is exposed, and the display unit 80 displays an image corresponding to accumulated data stored in the memory 60 while the imaging device 30 is exposed. Descriptions thereof will be given in more detail below.

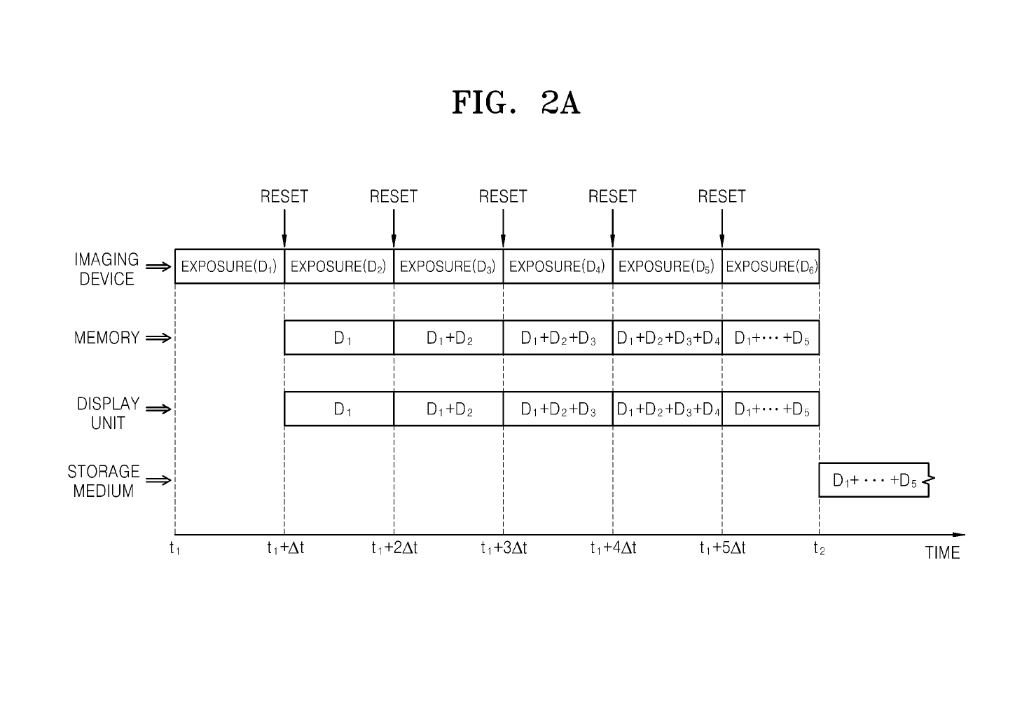

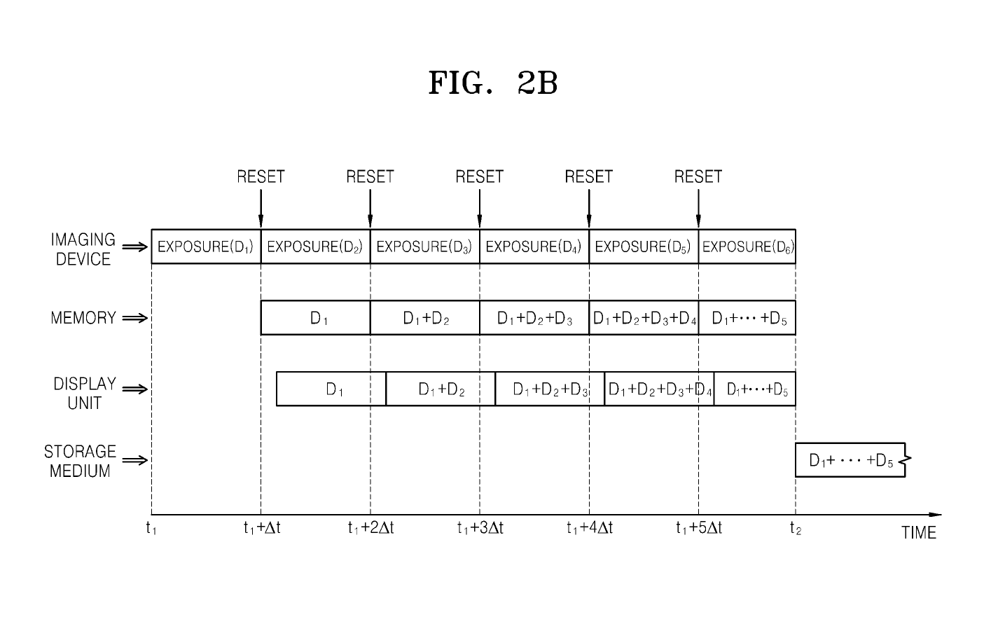

FIG. 2A is a timing diagram illustrating an example of processes performed during an image capturing operation of the digital photographing apparatus of FIG. 1. In the case where exposure of the imaging device 30 begins at a time point t₁, the imaging device 30 is exposed for a preset time interval Δt. Between the time points t₁ and t₁+Δt, the imaging device 30 generates data D₁. For example, since the imaging device 30 can generate different amounts of charges according to the amount of exposure, it may be considered that the data D₁ is data corresponding to the amount of charges generated by the imaging device 30 between the time points t₁ and t₁+Δt. At the time point t₁+Δt, storage of the data D₁ generated by the imaging device between the time points t₁ and t₁+Δt in the memory 60 begins. Furthermore, an image corresponding to the data D₁ generated by the imaging device between the time points t₁ and t₁+Δt is displayed on the display unit 80. The data D₁ stored in the memory 60 may have a significantly large resolution, whereas the resolution of a display unit of a digital photographing apparatus may be relatively small. Therefore, an image corresponding to accumulated data stored in the memory 60 is not displayed in its original form on the display unit 80, but is displayed after being resized (reduced).

Furthermore, since the storage of the data D₁ in the memory 60 begins at the time point t₁+Δt, various changes may be made to the current embodiment; i.e., images may be displayed on the display unit 80 at a delayed time point, rather than at the time point t₁+Δt as shown in FIG. 2B. Furthermore, it is illustrated in FIGS. 2A and 2B that the data D₁ is stored in the memory 60 between the time points t₁+Δt and t₁+2Δt. Here, it may mean that the data D₁ is stored in the memory 60 throughout a time interval Δt between the time points t₁+Δt and t₁+2Δt. Alternatively, it may mean that the storage of the data D₁ begins at the time point t₁+Δt and is completed before the time point t₁+2Δt, so that the data D₁ is stored in the memory 60 as of the time point t₁+2Δt. Alternately, display of an image corresponding to the data D₁ on the display unit 80 may begin as the storage of the data D₁ in the memory 60 begins. Alternately, an image corresponding to the data D₁ may be displayed on the display unit 80 after the storage of the data D₁ in the memory 60 is completed. Accordingly, various changes may be made to the current embodiment.

After the imaging device 30 is exposed for a preset time interval Δt between the time points t₁ and t₁+Δt, the imaging device 30 is exposed again for the preset time interval Δt between the time points t₁+Δt and t₁+2Δt. Here, the data D₁ generated by the imaging device 30 during exposure between the time points t₁ and t₁+Δt is transmitted to the memory 60 at the time point t₁+Δt, and thus data D₂ generated by the imaging device 30 during exposure between the time points t₁+Δt and t₁+2Δt is new data which is not a duplicate of the data D₁ generated by the imaging device 30 during exposure between the time points t₁ and t₁+Δt. For example, if the imaging device 30 is a type of imaging device that generates charges according to the amount of light incident thereto, charges generated by the imaging device 30 during a preset time interval Δt between the time points t₁ and t₁+Δt are completely discharged from the imaging device 30 at the time point t₁+Δt, and the imaging device 30 generates new charges for the preset time interval Δt between the time points t₁+Δt and t₁+2Δt according to the amount of light incident thereto. For precision, the imaging device 30 may be reset at the time point t₁+Δt. In other words, in the case where data generated by the imaging device 30 during every time interval Δt is accumulatively stored in the memory 60 while the imaging device 30 is exposed, the imaging device 30 may be reset at every preset time interval Δt.

Data D₂ generated by the imaging device 30 during the preset time interval Δt between the time points t₁+Δt and t₁+2Δt is accumulatively stored in the memory 60 after the preset time interval Δt from the time point t₁+Δt. In other words, the data D₁ generated by the imaging device 30 during the preset time interval Δt between the time points t₁ and t₁+Δt and the data D₂ generated by the imaging device 30 during the preset time interval Δt between the time points t₁+Δt and t₁+2Δt are accumulatively stored in the memory 60, which is indicated as D₁+D₂ in FIGS. 2A and 2B. The display unit 80 displays images from the accumulated data D₁+D₂ stored in the memory 60. In other words, when an image corresponding to accumulated data stored in the memory 60 is displayed on the display unit 80, an image displayed on the display unit 80 may be updated to a next image corresponding to the accumulated data stored in the memory 60 at every time interval Δt. In this case, an image corresponding to accumulated data stored in the memory 60 may be displayed after being resized (reduced).

Accordingly, a digital photographing apparatus according to the current embodiment accumulatively stores data generated by the imaging device 30 during every preset time interval while the imaging device 30 is exposed, and the display unit 80 displays an image corresponding to accumulated data stored in the memory 60 while the imaging device 30 is exposed. Therefore, the brightness of images displayed on the display unit 80 increases as time passes. In other words, as time passes, images corresponding to longer exposure of an imaging device are displayed. Thus, a user can view images displayed on the display unit 80, and, when an image at an appropriate exposure is displayed on the display unit 80, the user may operate a digital photographing apparatus to store an image file corresponding to the image in the storage medium 70. In other words, when there is a signal from a user while the imaging device 30 is exposed, a digital photographing apparatus according to the current embodiment can store image files, corresponding to accumulated data stored in the memory 60, in the storage medium 70.

For example, in a timing diagram as shown in FIGS. 2A and 2B, when a user operates a digital photographing apparatus and stops an image capturing operation at a time point t₂, an image file corresponding to accumulated data D₁+D₂+ . . . D₅ stored in the memory 60, which is data corresponding to an image displayed on a display unit at the time interval t₂, is stored in the storage medium 70.

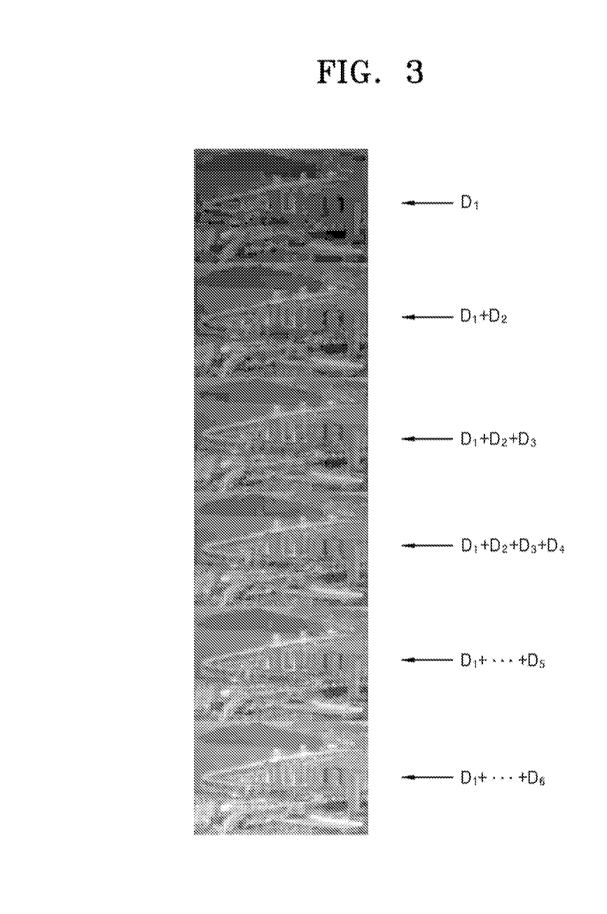

FIG. 3 is a diagram showing images displayed on a display unit when images are captured by using the digital photographing apparatus of FIG. 1. As shown in FIG. 3, an image corresponding to data D₁+D₂ is brighter than an image corresponding to data D₁. Accordingly, the brightness of images increases as time passes. When a user views images displayed on the display unit 80 and an image with appropriate brightness is displayed, an image file corresponding to the image may be stored in the storage medium 70. When an image corresponding to data D₁+D₂+ . . . D₅ is displayed on the display unit 80, if the user operates the digital photographing apparatus to store an image file corresponding to the data D₁+D₂+ . . . D₅ in the storage medium 70, the image corresponding to data D₁+D₂+ . . . D₆ may not be displayed on the display unit 80.

Furthermore, according to a modified embodiment, an image file corresponding to accumulated data stored in the memory 60 may be stored in the storage medium 70 at every preset time interval Δt while the imaging device 30 is exposed. In this case, five image files, from an image file corresponding to the data D₁ to an image file corresponding to the data D₁+D₂+ . . . D₅, may be stored in the storage medium 70. In this case, a user can later choose an image file corresponding to an image having a desired effect from among a plurality of image files.

Accordingly, a digital photographing apparatus according to the present invention enables a user to observe image changes, such as changes in brightness, due to exposure of an imaging device for a longer period of time and to store an image file corresponding to an image with appropriate brightness. Thus, user convenience can be maximized.

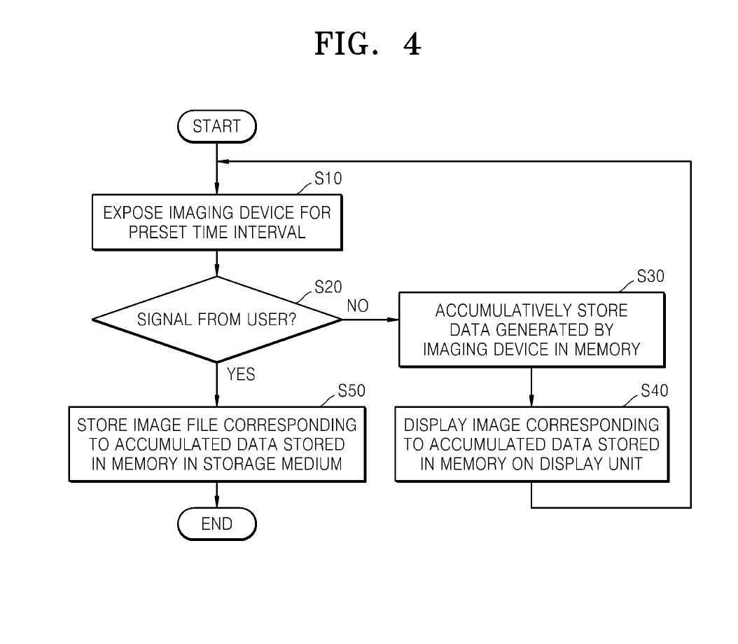

FIG. 4 is a flowchart of a method of controlling a digital photographing apparatus, according to an embodiment of the present invention. According to the method, data generated by an imaging device is accumulatively stored in a memory while the imaging device is exposed, and an image corresponding to accumulated data stored in the memory during the exposure of the imaging device is displayed on a display unit.

More particularly, an imaging device is exposed for a preset time interval (operation S10). Next, it is determined whether a stop signal is applied by a user or not (operation S20). If there is no stop signal applied by the user, data generated by the imaging device is accumulatively stored in a memory (operation S30). First data generated by the imaging device during the preset time interval is stored in its original form in the memory. Then, an image corresponding to accumulated data stored in the memory is displayed on a display unit. Next, the operations S10 and S20 are repeated. Here, if there is no stop signal applied by the user, data generated by the imaging device during the preset time interval is accumulatively stored in the memory again. Here, accumulative storage means combining new data to data already stored in the memory. For example, if pre-existing data corresponding to a resolution (x, y) is D_{1(x, y)} and new data corresponding to the resolution (x, y), which is generated by the imaging device during the preset time interval, is D_{2(X, y)}, accumulatively stored data corresponding the resolution (x, y) may be D_{1(x, y)}+D_{2(x, y)}. When a stop signal is applied by a user during repetition of the operations above, an image file corresponding to accumulated data stored in the memory is stored in a storage medium (operation S50). According to the method of controlling a digital photographing apparatus according to the current embodiment, a user can observe changes of images, such as changes in brightness of images, due to exposure of an imaging device for a longer period of time, and can store an image file corresponding to an image having an appropriate brightness. Thus, user convenience can be maximized.

When an image corresponding to accumulated data stored in the memory is displayed on a display unit while an imaging device is exposed, the image displayed on the display unit is updated at every time interval to a next image corresponding to accumulated data stored in the memory, so that a user can confirm an image corresponding to a particular image file to be stored in the storage medium by stopping an image capturing operation of a digital photographing apparatus.

When data generated by the imaging device is accumulatively stored in the memory at every time interval while the imaging device is exposed, the imaging device may be reset every time interval, so that the imaging device can generate precise data for every time interval.

Furthermore, while the imaging device is exposed, image files corresponding to accumulated data stored in the memory may be stored in the storage medium at every time interval, so that image files corresponding to a plurality of images with different exposure times are stored in the storage medium.

In this case, a user can review images corresponding to the image files to choose an image file corresponding to an appropriate image.

Furthermore, when an image corresponding to accumulated data stored in the memory is displayed on the display unit, the resolution of the image corresponding to the accumulated data stored in the memory may be significantly large, whereas the resolution of the display unit of the digital photographing apparatus may be relatively small. Therefore, when an image corresponding to accumulated data stored in the memory is displayed on the display unit while the imaging device is exposed, the image corresponding to the accumulated data may be displayed after being resized (reduced).

A computer program for executing a method of controlling a digital photographing apparatus according to the embodiments described above and modified embodiments may be stored in a storage medium. Here, the term ‘storage medium’ may refer to the storage medium 70 shown in FIG. 1, the memory 60 shown in FIG. 1, or other storage media. Examples of the other storage media include magnetic storage media (i.e. read-only memory (ROM), floppy disks, hard disks, etc.) and optical storage media (i.e. CD-ROMS, digital versatile discs (DVDs), etc.).

The system or systems described herein may be implemented on any form of computer or computers and the components may be implemented as dedicated applications or in client-server architectures, and can include functional programs, codes, and code segments. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions or computer readable codes executable on the processor on a computer-readable media such as read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

Numerous modifications and adaptations will be readily apparent to those skilled in this art without departing from the spirit and scope of the present invention.

What is claimed is:

1. A digital photographing apparatus comprising:
an imaging device for generating data from light incident thereto;
a memory for storing data generated by the imaging device;
a display unit for displaying an image corresponding to data generated by the imaging device or an image corresponding to data stored in the memory; and
a storage medium for storing an image file corresponding to data generated by the imaging device or an image file corresponding to data stored in the memory,
wherein data generated by the imaging device during a preset time interval is accumulatively stored in the memory while the imaging device is exposed, and
the display unit displays an image corresponding to accumulated data stored in the memory while the imaging device is exposed.

2. The digital photographing apparatus of claim 1, wherein, when data generated by the imaging device during the preset time interval is accumulatively stored in the memory while the imaging device is exposed, the imaging device is reset at every preset time interval.

3. The digital photographing apparatus of claim 1, wherein, when an image corresponding to accumulated data stored in the memory is displayed while the imaging device is exposed, an image displayed on the display unit is updated at every preset time interval to a next image corresponding to accumulated data stored in the memory.

4. The digital photographing apparatus of claim 1, wherein, when a signal is applied by a user while the imaging device is exposed, an image file corresponding to accumulated data stored in the memory is stored in the storage medium.

5. The digital photographing apparatus of claim 1, wherein an image file corresponding to accumulated data stored in the memory is stored in the storage medium at every time interval.

6. The digital photographing apparatus of claim 1, wherein, when an image corresponding to accumulated data stored in the memory is displayed while the imaging device is exposed, the image corresponding to the accumulated data stored in the memory is displayed after being resized.

7. A method of controlling a digital photographing apparatus, which comprises an imaging device for generating data from light incident thereto, a memory for storing data generated by the imaging device, a display unit for displaying an image corresponding to data generated by the imaging device or an image corresponding to data stored in the memory, and a storage medium for storing an image file corresponding to data generated by the imaging device or an image file corresponding to data stored in the memory, the method comprising:
accumulatively storing data generated by the imaging device in the memory at every preset time interval while the imaging device is exposed; and
displaying an image corresponding to accumulated data stored in the memory on the display unit while the imaging device is exposed.

8. The method of claim 7, wherein, when data generated by the imaging device during the preset time interval is accumulatively stored in the memory while the imaging device is exposed, the method further comprises resetting the imaging device at every preset time interval.

9. The method of claim 7, wherein, when an image corresponding to accumulated data stored in the memory is displayed while the imaging device is exposed, the method further comprises updating an image displayed on the display unit at every preset time interval to a next image corresponding to accumulated data stored in the memory.

10. The method of claim 7, wherein, when a signal is applied by a user while the imaging device is exposed, the method further comprises storing an image file corresponding to accumulated data stored in the memory in the storage medium.

11. The method of claim 7, wherein an image file corresponding to accumulated data stored in the memory is stored in the storage medium at every time interval.

12. The method of claim 7, wherein, when an image corresponding to accumulated data stored in the memory is displayed while the imaging device is exposed, the method further comprises displaying the image corresponding to the accumulated data stored in the memory after being resized.

13. A computer program product, comprising a computer usable medium having a computer readable program code embodied therein, said computer readable program code adapted to be executed to implement a method of controlling a digital photographing apparatus, which comprises an imaging device for generating data from light incident thereto, a memory for storing data generated by the imaging device, a display unit for displaying an image corresponding to data generated by the imaging device or an image corresponding to data stored in the memory, and a storage medium for storing an image file corresponding to data generated by the imaging device or an image file corresponding to data stored in the memory, the method comprising:
accumulatively storing data generated by the imaging device in the memory at every preset time interval while the imaging device is exposed; and
displaying an image corresponding to accumulated data stored in the memory on the display unit while the imaging device is exposed.
